(19) United States
(12) Patent Application Publication
(10) Pub. No.: US 2003/0014595 A1
(43) Pub. Date: Jan. 16, 2003

(54) Cache apparatus and cache method

(75) Inventors: Masahiro Doteguchi, Kawasaki (JP); Haruhiko Ueno, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/194,328

(22) Filed: Jul. 15, 2002

(30) Foreign Application Priority Data
Jul. 16, 2001 (JP) 2001-215429 ( PAT

(51) Int. Cl. G06F 12/08

(52) U.S. Cl. 711/130; 711/170; 711/173; 711/143

(57) ABSTRACT

In order to enable a plurality of access origins to effectively utilize a cache thereby to realize high-speed and stable processing, by measuring a frequency of access from the plurality of access origins, allocating a cache capacity based on the access frequency, and notifying an error, when it occurs, to an access origin having the allocation or to a predetermined access origin to process the error, there is provided a cache apparatus for enabling a plurality of access origins to make access to a cache memory. The cache apparatus comprises a unit for setting a cache capacity into which each access origin can charge data; a unit for charging data into an area within the set cache capacity in response to a request from each access origin based on the cache capacity; and a unit for reading data from the cache memory and notifying the data without depending on the set cache capacity when each access origin has made a reference request. There is also provided a cache method that is executed by using the cache apparatus or the like.

### BACKGROUND OF THE INVENTION

1. Field of the Invention

The present invention relates to a cache apparatus and a cache method that enable a plurality of access origins to make access to a cache memory.

2. Description of the Related Art

In order to facilitate the understanding of problems that a conventional cache apparatus and a conventional cache method have, a structure and operation of a representative example of a cache apparatus relating to a conventional technique will be explained below based on FIG. 1 as shown in “Brief Description of the Drawings” to be described later.

Conventionally, a plurality of CPU 1 and CPU 2 charge (or load) data into a cache apparatus, and execute processing at high speed by referring to the charged data (or the loaded data), as shown in FIG. 1.

In the cache apparatus shown in FIG. 1, there have been the following problems. When one of the CPUs tries to charge new data, there may be no vacant area into which this data can be charged. In this case, this CPU erases old data from one of areas and charges the new data into this area. Therefore, when the other CPU next tries to refer to the old data, this CPU cannot refer to the old data, as this data has been erased. Consequently, the processing speed of this CPU is changed and becomes unstable as the capacity of the cache is used by the first CPU.

### SUMMARY OF THE INVENTION

In order to solve these problems, the present invention has an object of enabling a plurality of access origins to effectively utilize a cache to execute a high-speed and stable processing, by measuring access frequencies of the access origins, allocating a cache capacity or ways to the access origins based on the access frequencies, and notifying an error, when it occurs, to an access origin having the allocation or a predetermined access origin.

In order to achieve the above object, the present invention provides a cache apparatus that enables a plurality of access origins to make access to a cache memory. The cache apparatus comprises a unit for setting a cache capacity into which each access origin can charge data; a unit for charging data into an area within the set a cache capacity in response to a request from each access origin based on the cache capacity; and a unit for reading data from the cache memory and notifying the data without depending on the set cache capacity when each access origin has made a reference request.

Preferably, the cache apparatus of the present invention further comprises a unit for automatically adjusting the cache capacity into which data can be charged.

More preferably, the cache apparatus of the present invention further comprises a unit for measuring the frequency that each of the plurality of access origins makes access to the cache memory, wherein the frequency of making access to the cache memory is a frequency of making reference to the cache memory.

More preferably, the cache apparatus of the present invention further comprises a unit for notifying an error to an access origin allocated with an accessed area when the error occurred during an access made to the cache memory, or notifying the error to a predetermined access origin when there is no access origin having an allocation.

More preferably, in the cache apparatus of the present invention, the unit notifies the error to a predetermined access origin out of a plurality of access origins, when the plurality of access origins having the allocations exist or when the plurality of access origins having the allocations do not exist but there are a plurality of access origins.

Further, the present invention provides a cache method for enabling a plurality of access origins to make access to a cache memory. The cache method includes a step for setting a cache capacity into which each access origin can charge data; a step for charging data into an area within the set cache capacity in response to a request from each access origin based on the cache capacity; and a step for reading data from the cache memory and notifying the data without depending on the set cache capacity when each access origin has made a reference request.

Preferably, the cache method of the present invention further includes a step for automatically adjusting the cache capacity into which data can be charged.

More preferably, the cache method of the present invention further includes a step for measuring the frequency that each of the plurality of access origins makes access to the cache memory, wherein the frequency of making access to the cache memory is a frequency of making reference to the cache memory.

### BRIEF DESCRIPTION OF THE DRAWINGS

The above object and features of the present invention will be more apparent from the following description of the preferred embodiments with reference to the accompanying drawings, wherein:

FIG. 1 is a block diagram showing a typical example of a conventional type cache apparatus;

FIG. 2 is a block diagram showing a system structure of one embodiment of a cache apparatus based on the principle of the present invention;

FIG. 3A is a block diagram showing a structure of a main section of one embodiment of the present invention;

FIG. 3B is a diagram showing an example of a charge capacity setting register when a charge capacity is adjusted for each data entry;

FIG. 3C is a diagram showing an example of a charge capacity setting register when a charge capacity is adjusted for each way;

FIG. 3D is a time chart for explaining a data charge processing that is executed by using one embodiment of the present invention;

FIG. 4A is a diagram showing another example of a charge capacity setting register when a charge capacity is adjusted for each data entry;

FIG. 4B is a diagram showing another example of a charge capacity setting register when a charge capacity is adjusted for each way;

FIG. 5 is a flowchart for explaining one processing procedure for making access to a cache memory based on a cache method of the present invention;

FIG. 6 is a flowchart for explaining still another processing procedure for making access to a cache memory based on a cache method of the present invention;

FIG. 7 is a block diagram showing a system structure of another embodiment of a cache apparatus of the present invention.

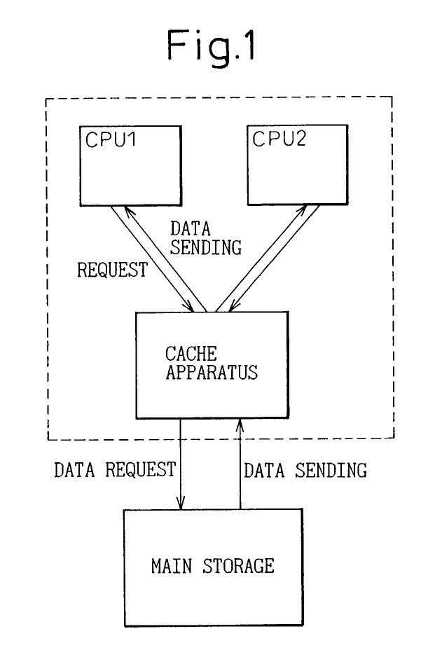

### DESCRIPTION OF THE PREFERRED EMBODIMENTS

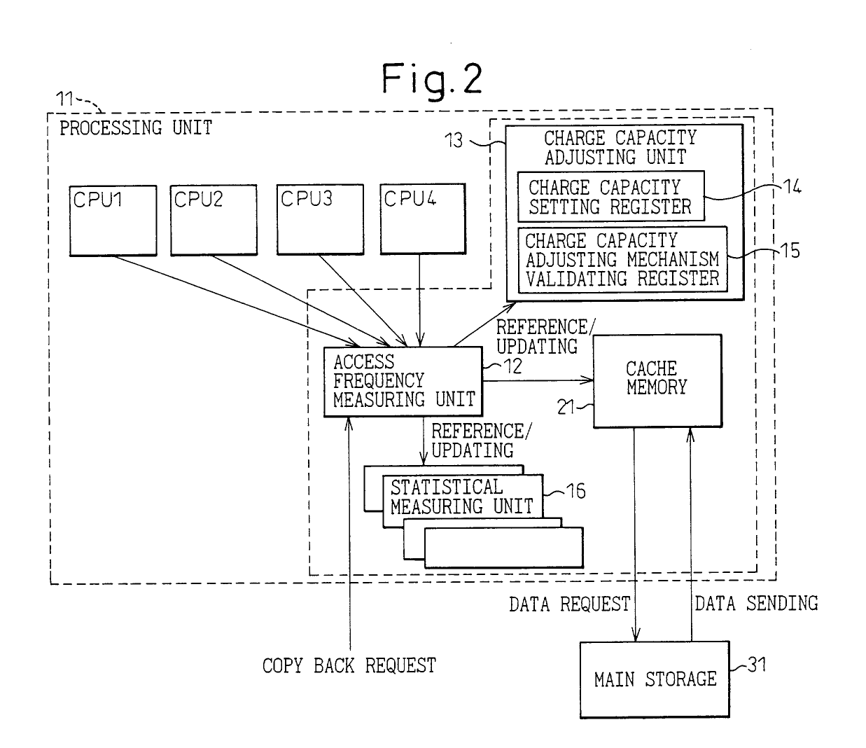

Structures and operations of preferred embodiments of the present invention will be explained sequentially in detail below, with reference to the attached drawings (FIG. 2 to FIG. 7).

FIG. 2 is a block diagram showing a system structure of one embodiment of a cache apparatus based on the principle of the present invention. Hereinafter, constituent elements similar to those described above will be explained by attaching the same reference numbers to these elements.

In FIG. 2, a cache memory 21 has the function of charging data and referring to the charged data.

An access frequency measuring unit 12 has the function of monitoring and counting an access made from an access origin (such as a CPU).

A charge capacity adjusting unit 13 has the function of adjusting a charge capacity (a capacity or a way) of an access origin based on an access frequency or the like.

Next, the operation will be explained.

The access frequency measuring unit 12 measures a frequency in which each of a plurality of access origins makes access to a cache memory 21. The charge capacity adjusting unit 13 sets a cache capacity or a way to be allocated to each access origin corresponding to a measured access frequency, charges data requested from an access origin into an area within the cache capacity or an area within the way based on the set cache capacity or the set way, and reads data from the cache memory 21 and notifies this data when an access origin has made a reference request.

In this case, the access frequency is a frequency of making reference to the cache memory 21.

Further, when an error has occurred while the cache memory 21 is being accessed, the error is notified to an access origin that has been allocated with an accessed area, or is notified to a predetermined access origin when there is no access origin having an allocation.

When there are a plurality of access origins having allocations, or when the plurality of access origins having the allocations do not exist but there are a plurality of access origins, the error is notified to a predetermined access origin out of a plurality of access origins.

Therefore, it is possible to enable a plurality of access origins to effectively utilize a cache to realize the execution of a high-speed and stable processing, by measuring access frequencies of the access origins (for example, CPUs), allocating a cache capacity or ways to the access origins based on the access frequencies, and notifying an error to an access origin having an allocation or a predetermined access origin when the error has occurred.

More specifically, in FIG. 2, a processing unit 11 executes various kinds of processing according to a program. In the processing unit 11, a plurality of CPUs 1, 2, 3 and 4 as access origins refer to one cache memory 21, and each of the CPUs 1, 2, 3 and 4 charges (writes) data into a cache area or a way that has been allocated to the CPU per se. The processing unit 11 is constructed of the CPUs 1, 2, 3 and 4, the access frequency measuring unit 12, the charge capacity adjusting unit 13, the cache memory 21, and a statistical measuring unit 16.

The CPUs 1, 2, 3 and 4 are examples of access origins, and they carry out various kinds of processing based on a program.

The access frequency measuring unit 12 monitors access made to the cache memory 21 from the CPUs 1, 2, 3 and 4 or external access origins, and measures the number of access thereby to measure an access frequency (a reference frequency, a reading or writing frequency, etc.).

The charge capacity adjusting unit 13 adjusts a charge capacity based on the access frequency of each access origin measured by the access frequency measuring unit 12. The charge capacity adjusting unit 13 is constructed of a charge capacity setting register 14, and a charge capacity adjusting mechanism validating register 15.

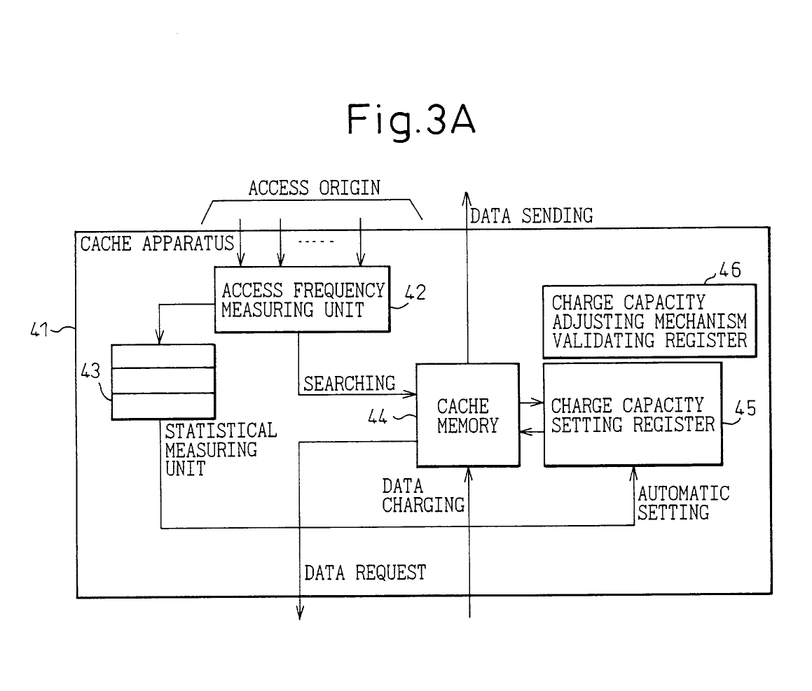

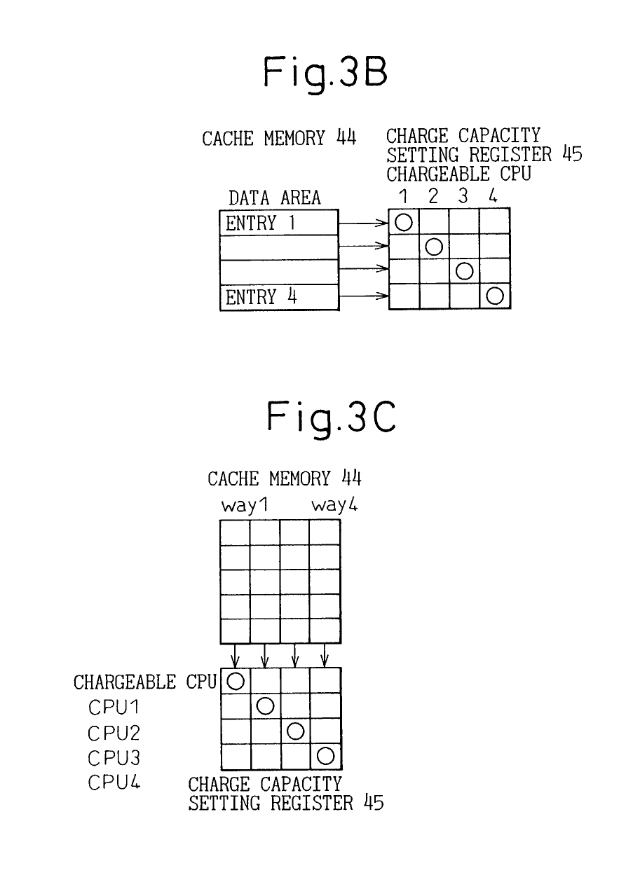

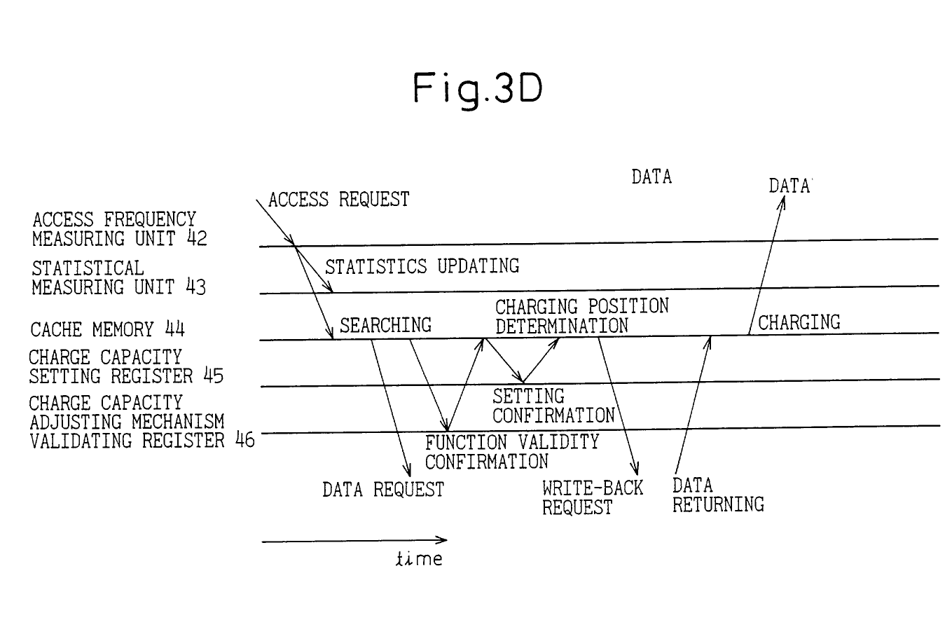

The charge capacity setting register 14 is a register (to be described later with reference to FIG. 3 to FIG. 5) to which a charge capacity (a memory cache capacity, or the way number corresponding to a chargeable way) of the cache memory 21 is set based on the access frequency of an access origin or by software setting.

The charge capacity adjusting mechanism validating register 15 is a register to which data (or a flag) is set that makes valid the charge capacity set in the charge capacity setting register 14.

The statistical measuring unit 16 measures a frequency of access made from each access origin to the cache memory 21 (a reference frequency, a charging frequency, or a reference and charging frequency).

A main storage 31 is an external storage for storing a large quantity of data. Data of high reference frequency is fetched from the main storage 31 and is stored into the cache memory 21.

The cache memory 21 is a high-speed accessible memory into which data can be charged (written) or from which data is referred to.

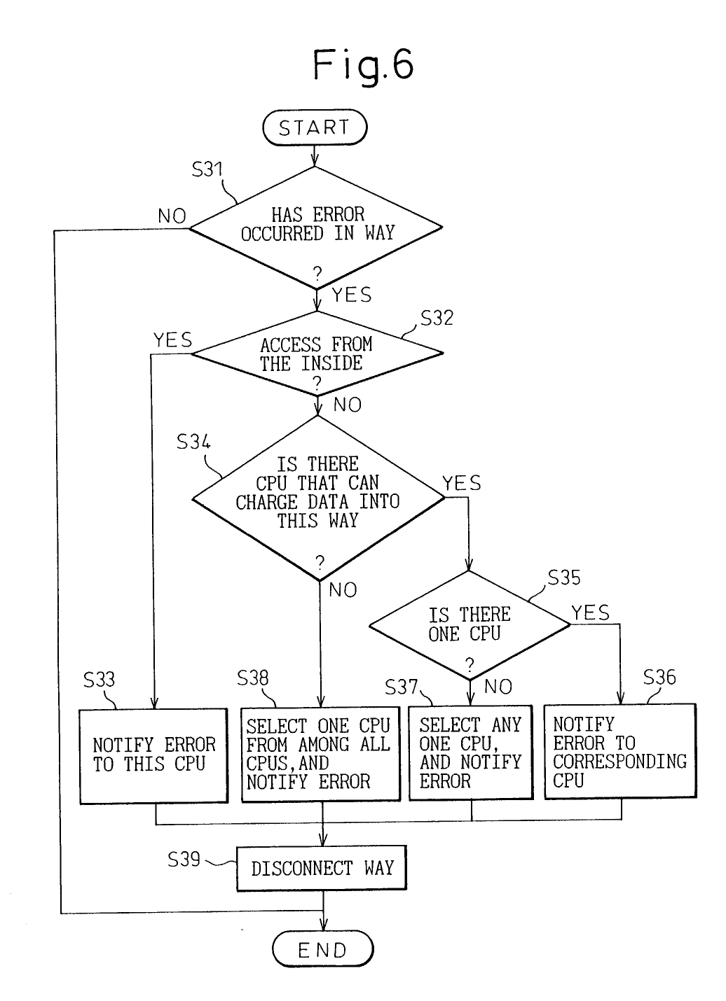

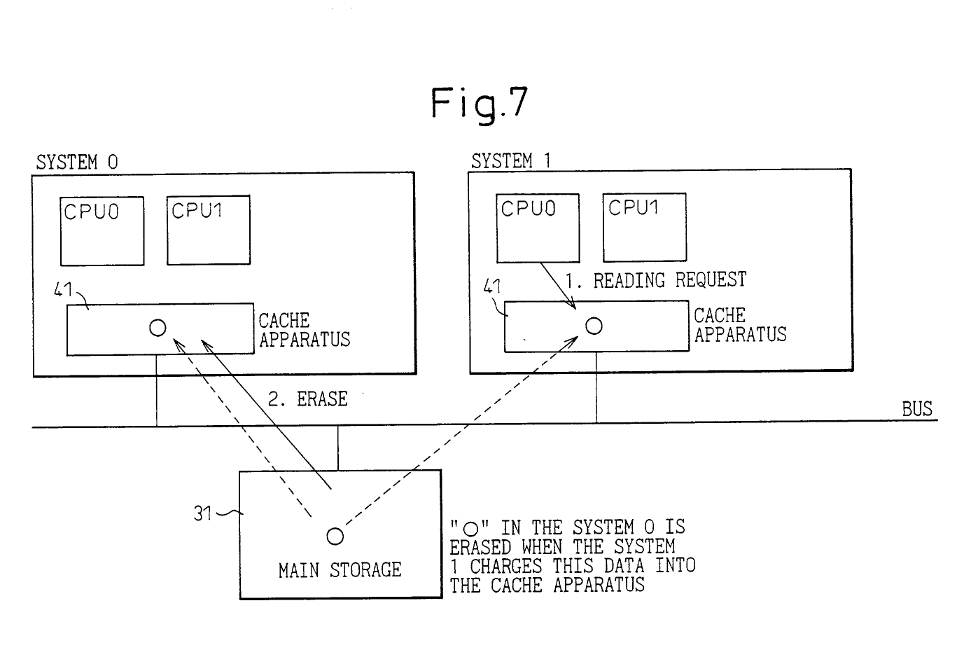

A copy back request is a copy back request from the other access origin not shown (for example, a CPU of the other processing unit 11 not shown). As explained later with reference to FIG. 7, this is a request for making reference to or erasing data from a specific cache memory 21 (for example the data on the cache memory 21 in FIG. 2), when the data is to be charged into the other cache memory 21 in the state that the data on the main storage 31 has been charged to the cache memory 21 (please refer to FIG. 6 to be described later).

FIG. 3A is a block diagram showing a structure of a main section of one embodiment of the present invention. This shows a detailed structure diagram of a cache apparatus 41 that consists of the access frequency measuring unit 12, the charge capacity adjusting unit 13, the cache memory 21, and the statistical measuring unit 16 shown in FIG. 2.

In FIG. 3A, when an access origin has made a charging request, the cache apparatus 41 charges data into an area allocated to this access origin. When there is no vacant area, the cache apparatus 41 stores old data into a main storage 31, and charges the data into the vacant position. When an access origin has made a reference request, the cache apparatus 41 reads data from a cache memory 44, and returns this data. The cache apparatus 41 is constructed of a CPU access frequency measuring unit 42, a statistical measuring unit 43, the cache memory 44, a charge capacity setting register 45, and a charge capacity adjusting mechanism validating register 46.

The CPU access frequency measuring unit 42 measures the number of access made by each CPU to the cache memory 44, and calculates an access frequency per unit time.

In this case, the statistical measuring unit 43 has substantially the same function as in the statistical measuring unit 16 as mentioned in FIG. 2.

The cache memory 44 is a memory for temporarily holding data of the main storage to make it possible to execute high-speed access. It is possible to refer to or replace data independently of each other, for each data storage unit.

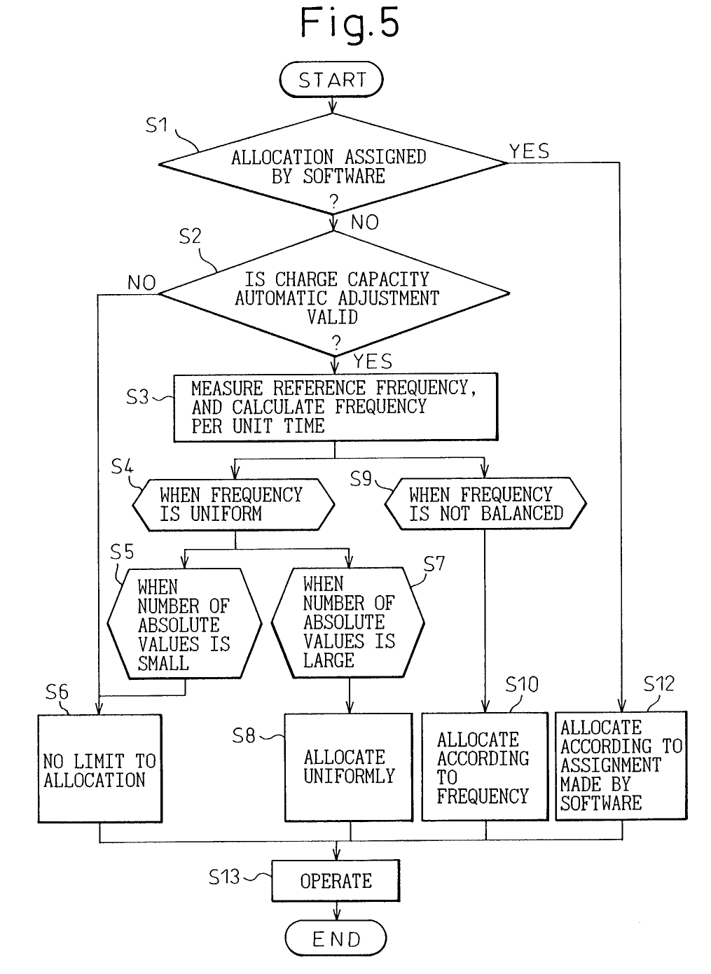

The charge capacity setting register 45 is a register in which it is set, for each CPU, whether it is possible to charge data into a data area of the cache memory 44. The setting to the charge capacity setting register 45 is carried out by a user or is automatically executed based on an access frequency (refer to FIG. 5 to be described later).

FIG. 3B shows an example of the charge capacity setting register 45 when the cache memory 44 does not have any ways. A chargeable CPU is assigned for each entry in this charge capacity setting register 45. In this example, a setting has been made such that a CPU1 can charge data into an entry 1, a CPU2 can charge data into an entry 2, a CPU3 can charge data into an entry 3, and a CPU4 can charge data into an entry 4. All CPUs can make reference to the entries of the cache memory 44 regardless of the setting of the charge capacity.

FIG. 3C shows an example of the charge capacity setting register 45 when the cache memory 44 has some ways. In this example, a setting has been made such that the CPU1 can charge data into a left-end way of the cache memory 44, and the CPU2 can charge data into a second way from the left and a right-end way of the cache memory 44. All CPUs can make reference to the entries of the cache memory 44 regardless of the setting of the charge capacity.

Based on the above structure, the access frequency of each CPU to the cache memory 44 within the cache apparatus 41 is measured. As the measured access frequency of a CPU becomes higher, this CPU can charge data into more ways (the permission of charging to the corresponding ways is set to the charge capacity setting register 45). Charging ways are automatically allocated to the cache memory 44, thereby to optimize the actual access frequency. As a result, it becomes possible to improve the total processing speed of the processing unit 11 by effectively utilizing the cache memory 44.

FIG. 3D is a time chart for explaining a data charge processing that is executed by using one embodiment of the present invention. The process of executing a data charge processing is shown in the following (1) to (8) according to the time chart shown in FIG. 3D.

(1) An access request from an access origin is caught by the access frequency measuring unit 42, and is recorded into the statistical measuring unit 43.

(2) The access request is sent to the cache memory 44. Making reference to the cache memory 44 has been permitted to all access origins (CPUs).

(3) When no data exists, data is requested from a main storage not shown.

(4) In order to determine a data charging position, the setting of the charge capacity adjusting mechanism validating register 46 is confirmed.

(5) When the setting is valid, the charge capacity setting register 45 is confirmed next, and a charging area is determined.

(6) When old data remains in the charging area, a request for writing the data back is sent to the main storage not shown.

(7) When the data has been returned, the data is charged into the charging area determined above.

(8) The data is sent to the access origin.

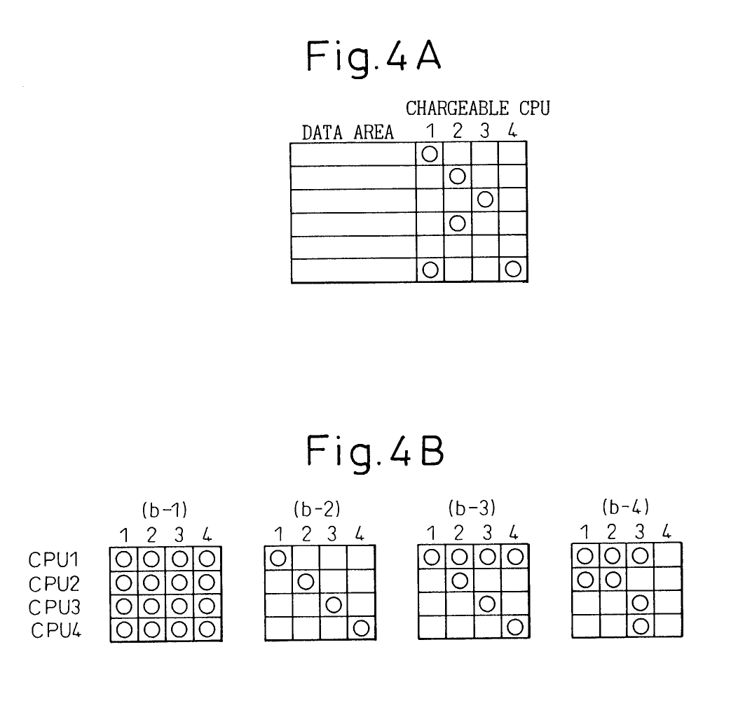

FIGS. 4A and 4B show other examples of the setting of the charge capacity setting register 45 of the present invention. FIG. 4A shows an example of setting and managing a CPU that charges data, for each data area. In this case, the cache memory 44 is divided into predetermined data areas, and a CPU (access origin) that is permitted to charge data into one of the divided data areas is set and managed. All CPUs (access origins) are permitted to make reference (all CPUs can read data from the cache memory 44).

As explained above, it is possible to set CPUs (access origins) that are permitted to charge data, for each predetermined size of data area of the cache memory 44. The set CPUs can charge (write) data into only the permitted data areas, respectively.

FIG. 4B shows an example of setting and managing a CPU that charges data, for each way. In this instance, a CPU (access origin) that is permitted to charge data is set and managed, for each way through which it is possible to independently make access to the cache memory 44. All CPUs (access origins) are permitted to make reference (all CPUs can read data from the cache memory 44).

A portion of (b-1) in FIG. 4B shows an example of a setting that all CPUs 1, 2, 3 and 4 can charge data into all ways 1, 2, 3 and 4.

A portion of (b-2) in FIG. 4B shows an example of a setting that the CPUs 1, 2, 3 and 4 can charge data into the ways 1, 2, 3 and 4, each into one way, respectively.

A portion of (b-3) in FIG. 4B shows an example of a setting that the CPU 1 can charge data into the ways 1, 2, 3 and 4, and the CPUs 2, 3 and 4 can charge data into the ways 2, 3 and 4, each into one way, respectively.

A portion of (b-4) in FIG. 4B shows an example of a setting that the CPU 1 can charge data into the ways 1, 2 and 3, the CPU 2 can charge data into the ways 1 and 2, and the CPUs 3 and 4 can charge data into the ways 3 and 4, each into one way, respectively.

As explained above, it is possible to set CPUs (access origins) that are permitted to charge data, for each way of the cache memory 44. The set CPUs can charge (write) data into only the permitted way(s), respectively.

Next, the process of allocating ways to access origins (CPUS) based on their access frequencies in the structures shown in FIG. 2 to FIG. 4B will be explained in detail below according to steps of a flowchart shown in FIG. 5.

This explains the process of automatically setting the charge capacity setting register 45 based on the information of the statistical measuring unit 43.

FIG. 5 is a flowchart for explaining one processing procedure for making access to a cache memory based on a cache method of the present invention.

Referring to FIG. 5, at step S1, it is decided whether or not there has been an allocation made by software or not. When the decision is YES, at step S12, the allocation assigned by software is set to the charge capacity setting register 45 shown in FIG. 3A explained above. The operation is started at step S13. At step S13, when there is a request for charging data into a way from a CPU, the data is written into the corresponding way of the cache memory 44, based on the information set in the charge capacity setting register 44 (When there is no vacant way, old data is stored into the main storage 31 to make one way vacant, and then the data is written into this way). When the decision is NO at step S1, the process proceeds to step S2.

At step S2, it is decided whether or not the charge capacity automatic adjustment is valid. In other words, it is decided whether or not the charge capacity automatic adjustment has been set valid in the charge capacity adjusting mechanism validating register 46 shown in FIG. 3A. When the decision is YES, the process proceeds to step S3. On the other hand, when the decision is NO, it is decided at step S6 that there is no limit to the allocation, and the operation is started at step S13.

At step S3, the reference frequency is measured, and the frequency per unit time is calculated. In other words, the reference frequency of each CPU to the cache memory 44 (or the reference frequency to each way of the cache memory 44) is measured, and the reference frequency per unit time is calculated.

At step S4, when the frequency is uniform, the process proceeds to step S5 or S7. In other words, when the reference frequency calculated at step S3 is substantially uniform, the process proceeds to step S5 or S7.

At step S5, when there is a small number of absolute values, it is decided at step S6 that there is no limit to the allocation. In other words, as it has been made clear at steps S4 and S5 that the frequency is uniform and that there is a small number of absolute values respectively, it is decided at step S6 that there is no limit to the allocation (all CPUs are permitted to charge data into all ways of the cache memory 44). At step S13, the operation is carried out according to the allocation.

At step S7, when there is a large number of absolute values, the allocation is carried out uniformly at step S8. Then, at step S13, the operation is carried out according to the allocation.

At step S9, when the frequency is not balanced, the allocation is carried out according to the frequency at step S10. In other words, when the reference frequency calculated at step S3 is not balanced, it is decided at step S10 that the ways of the cache memory 44 are allocated according to the frequencies, respectively. Then, at step S13, the operation is carried out according to the allocation.

As explained above, it is possible to automatically allocate the actual charging of each CPU to the cache memory 44 that reflects the reference to the cache memory 44, by measuring the reference frequency of each CPU to the cache memory 44 (or the reference frequency to each way of the cache memory 44), and by allocating the charging to the ways of the cache memory 44 based on the measured frequency.

FIG. 6 is a flowchart for explaining still another processing procedure for making access to a cache memory based on the cache method of the present invention. This is a flowchart for determining one of CPUs to which an error is to be notified thereby to process the error, when the error has occurred.

Referring to FIG. 6, at step S31, it is decided whether or not an error has occurred in a way or not. When the decision is YES, the process proceeds to step S32. When the decision is NO, the processing ends.

At step S32, it is decided whether or not an access has been made from the inside. When the decision is YES, the error is notified to this CPU at step S33. On the other hand, when the decision is NO, the process proceeds to step S34.

At step S34, it is decided whether or not there is a CPU that charges data into this way. When the decision is YES, it has been made clear by YES at step S31 that there is a CPU that has been allocated to charge data into the way in which the error occurred. Therefore, it is decided at step S35 whether or not the number of CPUs is one. When the decision is YES, the error is notified to this one CPU at step S36. When the decision is NO, any one CPU is selected from among a plurality of CPUs, and the error is notified to this CPU at step S37. At step S39, the way is disconnected. On the other hand, when the decision is NO at step S34, it has been made clear that there is no CPU that has been allocated to charge data into the way in which the error occurred. Therefore, one optional CPU is selected from among all CPUs at step S38 (for example, a CPU having a small number is selected), and the error is notified to this CPU. At step S39, the way is disconnected.

Based on the above, it becomes possible to carry out the following processing. When an error has occurred in any one of ways of the cache memory 44 and also when there is a CPU that has been allocated to charge data into the way in which the error has occurred, the error is notified to this CPU, and the way is disconnected. On the other hand, when there is no CPU that has been allocated to charge data into the way in which the error has occurred, the error is notified to any one CPU, and the way is disconnected. Therefore, when an error has occurred in any one of the ways, it is possible to automatically notify the error to a suitable CPU to make the CPU execute a processing (a processing such as the disconnection of the error way) efficiently and securely.

FIG. 7 is a block diagram showing a system structure of another embodiment of the cache apparatus of the present invention. This shows an example of a structure that the processing unit 11 shown in FIG. 2 is in the form of systems 0, 1, - - - which are connected to each other via buses, and are connected to a main storage 31 as shown. In this structure, data on the main storage 31 can be copied to a cache memory of only one of the systems 0, 1, - - - . For example, assume that any one of the CPUs within the system 1 is to read data “∘” on the main storage 31 in a state that the data “∘” on the main storage 31 shown in FIG. 7 has been copied to the cache memory of the system 0 as the data “∘” shown. In this case, the data “∘” on the system 0 is erased first. Then, this data “∘” is charged into the cache memory of the system 1 as the data “∘” shown, and the processing is started.

When any one CPU within the system 1 is to write onto the data “∘” on the main storage 31, the data “∘” on the system 0 is erased first. Then, this data “∘” is charged into the cache memory of the system 1 as the data “∘” shown, and the processing is started. Based on the writing, the data on the cache memory of the system 1 is updated. When an error has occurred in the cache memory of the system 0 at the time of erasing the data “∘” on this cache memory from the outside, this error is notified to the corresponding CPU as explained (please refer to FIG. 6), and the way is disconnected.

As explained above, according to the preferred embodiments of the present invention, the following structure is employed. The frequency of access from the access origin (for example, a CPU) is measured, and a cache capacity or a way is allocated based on this access frequency. At the same time, when an error has occurred, the error is notified to the access origin having the allocation or to a predetermined access origin to process the error. Therefore, it is possible to enable a plurality of access origins to effectively utilize a cache, thereby to realize high-speed and stable processing.

1. A cache apparatus for enabling a plurality of access origins to make access to a cache memory, the cache apparatus comprising:
a unit for setting a cache capacity into which each access origin can charge data;
a unit for charging data into an area within the set cache capacity in response to a request from each access origin based on the cache capacity; and
a unit for reading data from the cache memory and notifying the data without depending on the set cache capacity when each access origin has made a reference request.

2. The cache apparatus according to claim 1, further comprising a unit for automatically adjusting the cache capacity into which data can be charged.

3. The cache apparatus according to claim 1, further comprising a unit for measuring a frequency that each of the plurality of access origins makes access to the cache memory, wherein the frequency of making access to the cache memory is a frequency of making reference to the cache memory.

4. The cache apparatus according to claim 1, further comprising a unit for notifying an error to an access origin allocated with an accessed area when the error occurred during an access made to the cache memory, or notifying the error to a predetermined access origin when there is no access origin having an allocation.

5. The cache apparatus according to claim 2, further comprising a unit for notifying an error to an access origin allocated with an accessed area when the error occurred during an access made to the cache memory, or notifying the error to a predetermined access origin when there is no access origin having an allocation.

6. The cache apparatus according to claim 3, further comprising a unit for notifying an error to an access origin allocated with an accessed area when the error occurred during an access made to the cache memory, or notifying the error to a predetermined access origin when there is no access origin having an allocation.

7. The cache apparatus according to claim 4, wherein the unit notifies the error to a predetermined access origin out of a plurality of access origins, when the plurality of access origins having the allocations exist or when the plurality of access origins having the allocations do not exist but there are a plurality of access origins.

8. The cache apparatus according to claim 5, wherein the unit notifies the error to a predetermined access origin out of a plurality of access origins, when the plurality of access origins having the allocations exist or when the plurality of access origins having the allocations do not exist but there are a plurality of access origins.

9. The cache apparatus according to claim 6, wherein the unit notifies the error to a predetermined access origin out of a plurality of access origins, when the plurality of access origins having the allocations exist or when the plurality of access origins having the allocations do not exist but there are a plurality of access origins.

10. A cache method for enabling a plurality of access origins to make access to a cache memory, the cache method comprising:
a step for setting a cache capacity into which each access origin can charge data;
a step for charging data into an area within the set cache capacity in response to a request from each access origin based on the cache capacity; and
a step for reading data from the cache memory and notifying the data without depending on the set cache capacity when each access origin has made a reference request.

11. The cache method according to claim 10, further comprising a step for automatically adjusting the cache capacity into which data can be charged.

12. The cache method according to claim 10, further comprising a step for measuring a frequency that each of the plurality of access origins makes access to the cache memory, wherein the frequency of making access to the cache memory is a frequency of making reference to the cache memory.
